(19) United States
(12) Patent Application Publication
(10) Pub. No.: US 2013/0045313 A1
(43) Pub. Date: Feb. 21, 2013

(54) Low-Calorie, No Laxation Bulking System and Method for Manufacture of Same

(71) Applicant: Remington Direct LP, Fort Worth, TX (US)

(72) Inventors: George E. Steele, Fort Worth, TX (US); Donna Henry, Honey Grove, TX (US)

(73) Assignee: Remington Direct LP, Fort Worth, TX (US)

(21) Appl. No.: 13/657,647

(22) Filed: Oct. 22, 2012

Related U.S. Application Data
(63) Continuation of application No. 12/127,717, filed on May 27, 2008, now abandoned.
Application No. 12/127,717 is a continuation-in-part of application No. 12/037,813, filed on Feb. 26, 2008, now abandoned.
Application No. 12/037,813 is a continuation-in-part of application No. 11/828,915, filed on Jul. 26, 2007.
(60) Provisional application No. 60/833,551, filed on Jul. 26, 2006.

(51) Int. Cl. A23L 1/05; A23G 3/02; A23G 3/48; A23G 7/02; A23L 1/025

(52) U.S. Cl. 426/321; 426/455; 426/392; 99/484; 99/483

(57) ABSTRACT

A low-calorie, no laxation bulking system and a method for manufacture of same is disclosed. A hydrocolloid dry-blend mixture is added to water and blended in homogenizing equipment, forming a first mix. The first mix is transferred to a kettle/tank and a first liquid mixture comprising modified polydextrose is added to the first mix to form a second mix. A second liquid mixture comprising at least one acid is added to the second mix, and the resultant solution is maintained in a predetermined temperature range. The resultant solution is transferred to at least one aluminum pan. The at least one aluminum pan is lightly sprayed with a nozzle applying an atomized release agent and placed in a cooling room.

### CROSS-REFERENCE TO RELATED APPLICATIONS

The present application is a continuation of co-pending, commonly assigned U.S. patent application Ser. No. 12/127,717, entitled “Low-Calorie, No Laxation Bulking System and Method for Manufacture of Same,” which is a continuation-in-part of commonly assigned U.S. patent application Ser. No. 12/037,813, entitled “No Laxation, Low Flatulence Bulking System,” filed Feb. 26, 2008, which itself is a continuation-in-part of commonly assigned U.S. patent application Ser. No. 11/828,915, entitled “No Laxation, Low Flatulence Bulking System,” filed Jul. 26, 2007, which itself claims priority to U.S. Provisional Patent Application No. 60/833,551, entitled “No Laxation Bulking System,” filed Jul. 26, 2006, and is related to U.S. patent application Ser. No. 11/828,950, entitled “No Laxation Bulking System,” filed Jul. 26, 2007, the disclosures of which are hereby incorporated herein by reference.

### FIELD OF THE DISCLOSURE

The present disclosure relates generally to low-calorie, no laxation bulking systems and more particularly, to a system and method of manufacturing a low-calorie, no laxation bulking system for human ingestion.

### BACKGROUND

In recent years, controlling sugar, calories, fat and carbohydrates in the human diet has become more of a concern. Many humans desire to control these items to satisfy special dietary needs, i.e., individuals suffering from diabetes or other health problems. Other humans are attempting to eat more healthfully as a preventative measure and/or so as to address weight loss or maintenance concerns.

Regardless of what type of dietary needs a person has, typically snack foods are part of such diet. For example, those attempting to lose weight may ingest a number of small meals during the day, some of those meals being snack foods. Similarly, diabetics may require snack foods during the day in order to maintain a proper blood sugar level. Snack foods also may be eaten in order to provide energy or to deliver vitamins to the body. Thus, most humans incorporate snack foods into their diet, but the desire is to have a more healthful snack food. To prevent hunger, there exists a need for a food item to act as a low calorie stomach fill; this food item should be able to be consumed in large quantities to satiate hunger with no resultant weight gain.

Many consider confectionery items, such as candies, to be snack foods. In the past, candies have not been considered to be very healthy. In recent years, however, many confectioners have begun developing ways to make more health confectionery items, such as sugar-free candies. The confectionery industry has been developed around the properties of one ingredient—sucrose—and thus, when developing sugar-free candies, the desire is to find substitutes for sucrose that most closely mirror the properties, particularly the taste, of sucrose. There also is a need for a sugar-free confectionery snack that is low calorie as sugar-free confections typically are as caloric or only slightly less caloric than sucrose-based confectionery counterparts.

Polyols are often used as substitutes for sucrose in the manufacture of sugar-free confectionery items. Polyols typically used in sugar-free confectionery items include sorbitol, maltitol, lactitol, isomalt and polydextrose. Maltitol, which is produced by hydrogenating maltose in the form of pure maltose glucose syrup, is believed to most closely resemble the properties of sucrose in that, like sucrose, maltitol is a disaccharide. However, the use of polyols, particularly maltitol, in these sugar-free confectionery items can often be disadvantageous due to the laxative and flatulence-related effects that these polyols produce. The laxative and flatulence-related effects are osmotic in origin given that the unabsorbed material upsets the osmotic balance within the intestinal system, and the consequences can be unpleasant for many who ingest sugar-free confectionery items containing such polyols. Thus, there exists a need for a bulking system, such as in a soft candy product, that is sugar-free and low-calorie while avoiding the laxation and flatulence-related effects typically encountered with food items that incorporate polyols.

Sugar-free confectionery products are typically manufactured in a manner similar to that of sugar-containing confectionery products. In the case of soft candy products, the amount of time needed for the products to set prior to packaging and distribution is significant given that the formulation takes a long time to dry and cool. For example, when a confectionery item containing maltitol syrup is formed, typically it takes at least one to two days before the confectionery item has sufficiently dried and cooled. Thus, there exists a need for a method of manufacturing a bulking system that sets, dries and cools in a shorter period of time. There also exists a need for a method of packaging a bulking system in a manner that maintains the form and quality of the bulking system.

### SUMMARY

The present disclosure is directed to a method for manufacturing a low-calorie, no laxation bulking system. A hydrocolloid dry-blend mixture is blended with water in homogenizing equipment to form a first mix. The hydrocolloid dry-blend mixture preferably comprises at least one gum and erithritol. The homogenizing equipment preferably includes an inlet for receiving water and a hopper for receiving the hydrocolloid dry-blend mixture. The first mix is transferred to a mixing tank. A first liquid mixture comprising modified polydextrose is added to the first mix to a form a second mix. A second liquid mixture comprising at least one acid is then added to the second mix to form a moldable mix. The moldable mix is transferred to at least one aluminum pan. The at least one aluminum pan containing the moldable mix is then cooled in a cooling room for a predetermined range of time. Further embodiments of the present disclosure include spraying the at least one aluminum pan with an atomized release agent prior to cooling the at least one aluminum pan. In other embodiments, the moldable mix is depanned into a sealable container and nitrogen is introduced into the sealable container. The moldable mix also may be exposed to steam in a steam tunnel upon exiting the cooling room, and the moldable mix may be sanded with a blend of granulated erithritol and calcium silicate upon exiting the steam tunnel.

Another embodiment of the present disclosure is a system for manufacturing a low-calorie, no laxation bulking system. The system includes a homogenizer for meshing a hydrocolloid dry-blend mixture and water to form a first mix. The homogenizer preferably includes at least one adjunct high shear mixer. The system also is comprised of a mixing tank for blending the first mix with a first liquid mixture of modified polydextrose and a second liquid mixture comprising at least one acid to form a moldable mix. In certain embodiments, the system includes a depositer for depositing the moldable mix into the at least one aluminum pan. The system provides at least one aluminum pan for receiving the moldable mix and a cooling room for cooling the at least one aluminum pan for a predetermined range of time. The system also preferably includes at least one discharge pump attached to the homogenizer for pumping the first mix exiting the homogenizer. A flow meter also may be attached to the at least one discharge pump to determine the speed of the first mix as it exits the at least one discharge pump. A heat exchanger preferably is attached to the flow meter for heating the first mix before the first mix enters the mixing tank. In some embodiments, the homogenizer, the at least one discharge pump, the flow meter and the heat exchanger are housed in a single structure. Other embodiments provide for a nozzle for spraying the at least one aluminum pan receiving the moldable mix with an atomized release agent, a steam tunnel wherein when the moldable mix exits the cooling room, the moldable mix is exposed to steam for a period of time, and a tumbler for receiving the moldable mix upon exiting the steam tunnel, the tumbler containing a blend of granulated erithritol and calcium silicate.

A further embodiment of the present disclosure is directed to a method for manufacturing a quick setting, drying and cooling low-calorie, no laxation bulking system. A dry-blended mixture of erithritol and at least one gum is blended with water to form a first mix. Modified polydextrose and at least one acid are then blended with the first mix to form a solution. The solution is transferred to at least one aluminum pan, and the at least one aluminum pan containing the solution is cooled in a cooling room for a predetermined range of time.

The foregoing has outlined rather broadly the features and technical advantages of the present disclosure in order that the detailed description of the disclosure that follows may be better understood. Additional features and advantages of the present disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of this disclosure, reference is now made to the following description, taken in conjunction with the accompanying drawings, in which:

FIG. 1 depicts equipment preferably used in manufacturing a bulking system according to an embodiment of the present disclosure; and

FIG. 2 depicts a method for manufacturing a bulking system according to an embodiment of the present disclosure.

### DETAILED DESCRIPTION

The desire is to achieve a stable matrix using a bulking agent. This is achieved by using a sugar alcohol, such as erithritol, as well as a modified polydetrose, such as Litesse Ultra liquid, having high fiber content. The finished product includes high levels of erithritol dissolved in water and stabilized by hydrocolloids. The finished product is preferably zero sugar and low calorie providing for no laxation and reduced flatulence properties upon ingestion.

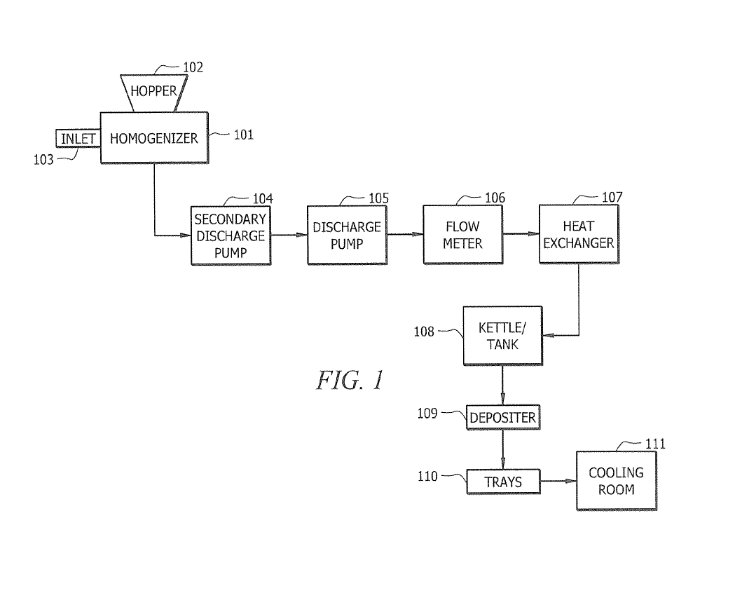

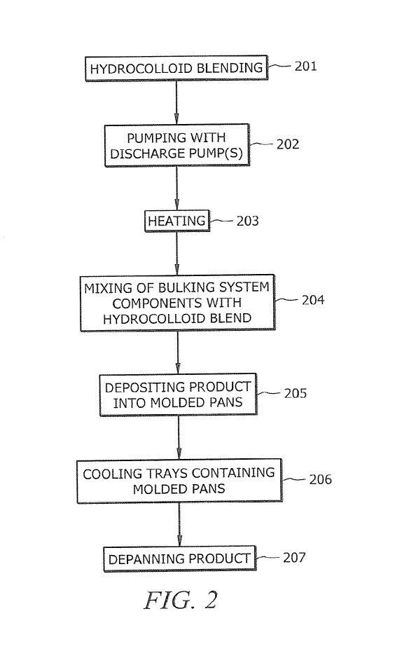

FIG. 1 depicts an embodiment of equipment preferably used in manufacturing the bulking system of the present disclosure. FIG. 2 depicts an embodiment of a process illustrating manufacturing of the bulking system of the present disclosure. FIGS. 1 and 2 preferably illustrate how the bulking system may be manufactured according to embodiments of the present disclosure. While several pieces of equipment are referenced in FIGS. 1 and it should be appreciated that the functions of the equipment also may be performed by a single piece of equipment according to some embodiments of the present disclosure. A first step in the bulking system manufacturing process comprises blending water with a hydrocolloid dry-blend mixture in a homogenizer. Homogenizer 101 is preferably used for hydrocolloid blending (FIG. 2, step 201) and preferably includes inlet 103 for metering water into homogenizer 101 as well as hopper 102 for the addition of the hydrocolloid dry-blend mixture. A preferred homogenizer is the Quadro Ytron model ZC1 as it permits sufficient control over the amount of shear applied and allows for use of large capacity hoppers and water inlets; however, other homogenizing equipment may be used without departing from the objects of the present disclosure. The hydrocolloid dry-blend mixture and water are meshed and high sheare together in homogenizer 101.

The hydrocolloid dry-blend mixture according to embodiments of the present disclosure is comprised of at least one gum and erithritol. Gums, such as gellan gums, are preferably used in forming the bulking system contemplated by the present disclosure so as to give the resultant gummy-like candy product, for example, its elastic texture. Preferable gellan gums include Kelcogel LT100 gellan gum and gellan gum F, as they are texture modifiers and stabilizers, and provide for an elastic gel texture when used in food-related applications. Other gums, including, but not necessarily limited to, carrageenan iota gum, carrageenan, gum Arabic, Xanthan, Karaya, Agar, locust bean/carob bean, carboxy methyl cellulose (CMC), and tragancanth and combinations thereof also preferably may be utilized in conjunction with gellan gums.

Erithritol also is incorporated into the hydrocolloid dry-blend mixture of the present disclosure. Erithritol is a polyol that acts as a novel bulk sweetener and has a caloric value close to zero (0.2 kcal/g). It is the only polyol presently known that has been shown not to cause laxation effects when incorporated into sugar-free edible items. Erithritol is believed to avoid this laxative effect because it is excreted through the kidneys, and as it has a low molecular weight, more than 90% is absorbed in the small intestine. This fraction is not metabolized and is excreted unchanged through the urine. Thus, it is shown to have the highest digestive tolerance of the polyols as studies have shown that adults ingesting up to 1 g of erithritol per day per kilogram of body weight do not show any gastrointestinal effects. Further, while conventional industry wisdom states that erithritol cannot be used above 8% volume in a stable bulking system because crystallization would occur to the point that the bulking system fails, a much larger volume of erithritol (over 8%) is utilized in the bulking system according to embodiments of the present disclosure. Fine erithritol granules are preferably used in the bulking system contemplated by the present disclosure. Granules, as opposed to a powder form, are preferably used as the powder version typically does not retain enough water for absorption. This lack of water retention may affect the process to the extent that setting of the bulking system may be hindered or even prevented. However, it should be appreciated that other forms of erithritol may be used without departing from the present disclosure. For example, erithritol in a syrup form may preferably be substituted for granular erithritol; however, a reduction in the amount of water used in the bulking system may be required and processing times likely would be altered. In other embodiments, less finely granulated erithritol or powdered erithritol also may be utilized.

In some embodiments of the present disclosure, preservatives, such as a blend of potassium sorbate and sodium hexametaphosphate (Glass H), may preferably be dissolved in the water before it is introduced into inlet 103 of homogenizer 101. Sodium hexametaphosphate and potassium sorbate are preservatives used to keep the bulking system fresh and to prevent mold from forming in the product. The preservatives should preferably be dissolved in the water prior to addition of any other components. Dissolution of the preservatives in water may be achieved by subjecting the mixing container to low agitation. It should be appreciated that if preservatives are incorporated into the bulking system of the present disclosure, no heat should be applied when the preservatives are blended into the water. These preservatives are regulated for use at approximately 0.1%.

Pectins are often used for making confectionery items. However, typically they have not been used in conjunction with gummy-like and/or soft candy bulking systems. This is due to the problem that if the pH does not fall within a specific range, the system formed may be unstable and may not set properly. It should be appreciated that in some embodiments of the present disclosure, pectins may be incorporated into the bulking system. If it is desirable to incorporate pectins, such as LM pectin, into the bulking system according to embodiments of the present disclosure, these pectins may form part of the hydrocolloid dry-blend mixture. Pectins also may be added to the water (following addition of preservatives, if used) under medium agitation until dispersed in the water. In the present disclosure, low methoxyl (LM) pectin, such as pectin LM/CP Kelco, is preferably used and is chosen for its ability to work with gellan gums in setting a firm gummy-like candy product. In some embodiments of the present disclosure, pectin amid AF020 also may be utilized because of its specific ability to work with the other components of the bulking system in setting the bulking system without stickiness being present in the product when it is placed in combination with sugar alcohols or polyols.

Gelatins also are often used for making confectionery items. Gelatins produced by acid hydrolysis are referred to as type A, whereas gelatins produced by alkaline hydrolysis are typically referred to as type B. The pH of type A gelatin is typically higher than the pH of type B gelatin (6.3-9.5 versus 4.5-5.2). Type A gelatins are preferably used for forming low-calorie, no laxation bulking systems contemplated by the present disclosure. Gelatins are typically not stable in acid, and thus any addition of acid should be as late as possible in the manufacturing process. Specifically, a gelatin type A 250 bloom is preferred. This gelatin has been selected based on having the specific ability to allow gelatin to set at a lower temperature (i.e., reduce the amount of time for setting as well as the temperature at which setting occurs) when used in combination with other ingredients as described and to produce a firm soft or hard candy product. Further, type A gelatin has the ability to work in conjunction with low methoxyl pectin and gellan gums. If it is desirable to use gelatins in the formulation of a bulking system according to embodiments of the present disclosure, gelatins are preferably incorporated into the hydrocolloid dry-blend mixture previously described.

Water is preferably metered into homogenizer 101 through inlet 103 at the time when water is needed in the blending process. No heat is preferably applied to the water when it is weighed or metered into homogenizer 101 as the water should preferably remain at room temperature so as to avoid adverse effects in the mixing and dispersion of the components of the bulking system. The hydrocolloid dry-blend mixture comprising at least erithritol and a gum is added to homogenizer 101 through hopper 102 and blended with water until even dispersement is achieved. In an embodiment of the present disclosure, approximately 10-15 minutes may be needed to achieve the desired dispersement of the first mix, although it should be appreciated that the time needed for dispersement may vary depending on the volume of the mix being prepared. It also should be appreciated that in a preferred embodiment, water that is introduced into homogenizer 101 starts at a temperature of approximately 130 degrees Fahrenheit, but the water temperature typically reduces to approximately 110 degrees Fahrenheit after mixing with the hydrocolloid dry-blend mixture.

The bulking system is preferably comprised of 9 to 50% erithritol, and 0 to 5% gums. Preferably, however, erithritol comprises approximately 20 to 30% of the bulking system. In embodiments containing pectin, the bulking system comprises 0 to 5% low methoxyl pectin and preferably 0-1% pectin. As the amounts and percentages of erithritol, pectin, and/or gums change due to scaling of the manufacturing process, it should be appreciated that the time required to fully blend these components also may change.

After completion of the mesh and high shear process, the blended mixture is preferably pumped by secondary discharge pump 104 (FIG. 2, step 202). When reference is made to a secondary discharge pump, it should be appreciated that it typically references a pump, such as a discharge pump, other than the pump that moves the first mix down the manufacturing line. The degree of pumping is determined by the actual speed and viscosity of the first mix exiting homogenizer 101 to be pumped into kettle/tank 108. It also should be appreciated that the pipes used in the processing stage of the manufacturing process should be insulated (jacketed). Before pumping the first mix into kettle/tank 108, the first mix preferably enters discharge pump 105. When the first mix is forced through the piping with discharge pump 105 (FIG. 2, step 202), it is preferably forced through flow meter 106 to determine and analyze the speed of the first mix as it exits the piping before entering heat exchanger 107. The flow or speed is preferably set for each batch of the bulking system and monitored as a control point of the viscosity of the bulking system being formed. It should be appreciated that controlling the speed of the bulking system may assist in reducing the amount of time needed to heat and form the bulking system. After the speed of the first mix is analyzed with flow meter 106, the first mix is preferably pumped into scrape surface heat exchanger 107. Heat exchanger 107 preferably has an outside wall that will heat the first mix before the mixture enters kettle/tank 108. The amount of heat applied depends on the mass of the first mix. It also should be appreciated that in the heating steps of the manufacturing process, other processing agents preferably may be used to increase the temperature of the composition being heated and reduce the amount of time that heat needs to be applied. Additionally or alternatively pressure, such as that achieved using a steam pressure cooker, also may be applied to hasten the manufacturing process. Again, while several pieces of equipment have been described with respect to what occurs in the manufacturing process prior to the first mix entering kettle/tank 108, it should be appreciated that in some embodiments the functions performed by the pieces of equipment depicted in FIG. 1 may be performed by a single piece of equipment, such as the Quadro Serendip HSH. It also should be appreciated that in certain embodiments, the first mix may be directly transferred from the homogenizing equipment to the kettle/tank without departing from the present disclosure.

Upon entering kettle/tank 108, the first mix of the hydrocolloid dry-blend mixture and water is heated (FIG. 2, step 203) in order to speed up the dispersion and blending process and that mixture is mixed with other bulking system components (FIG. 2, step 204). Kettle/tank 108 preferably includes at least one adjunct high shear mixer. This at least one adjunct high shear mixer may be located on the sweep or at the top portion of kettle/tank 108. Heat is preferably applied to the mixture until the temperature of the mixture reaches a first temperature of at least 190 degrees Fahrenheit under continuous agitation. Preferably the temperature of the mass mixture will reach approximately 195 degrees Fahrenheit before any further components of the bulking system are added to the mixture. When this first temperature is reached, it should be maintained for a period of time dependent on the type of equipment and amount of ingredients being used; however, in an embodiment, it is preferably maintained for approximately two minutes.

A first liquid mixture of modified polydextrose is then preferably added to the mixture, and, under continued agitation, the mixture is heated until a second temperature is reached. The first liquid mixture may be added to the first mix while the mixture still undergoes continuous agitation. The second temperature is preferably approximately 210 degrees Fahrenheit. The first liquid mixture of modified polydextrose is preferably weighed and held in a container separate from other components of the bulking system until at such time it is to be added during the blending process.

A preferred modified polydextrose for use is Litesse. Litesse is known as a specialty carbohydrate (polydextrose) that replaces sugar and fat while improving flavor, texture and mouthfeel in a variety of applications. It is low glycemic and thus suitable for consumers seeking low impact carbohydrates. Further, Litesse is water-soluble and is used as a bulking agent to make a variety of items lower in fat, calories and sugar-free while also high in fiber and having a good taste. The liquid formulation of Litesse (Litesse Ultra liquid) is preferable to use because there is typically less water present in the formulation, and it presents a clean taste with mildly sweet flavor. The percentage of Litesse Ultra liquid preferably present in the formulation can range from 0 to 20% of the resultant bulking system. This low percentage range for Litesse Ultra liquid is achieved by incorporating it with gellan gum and/or low methoxyl pectins to produce a firm candy product. It should be appreciated however that lower percentages of Litesse Ultra liquid may be used if another form of Litesse (such as Litesse II) is also used in the composition and/or a hydrogenated starch hydrolysate (HSH) also is employed. It also should be appreciated that a modified polydextrose other than Litesse may be employed without departing from the present disclosure.

Upon reaching the second temperature, a second liquid mixture of acids, flavors, sucralose, fruit concentrate, and colors is preferably added to the existing mixture under medium to medium high agitation. This second liquid mixture is preferably formed by weighing acids, colors, flavors, sucralose and fruit concentrate together in a container separate from the mixing kettle or tank. Each of the components of the second liquid mixture are preferably employed such that each component forms approximately 0 to 6% of the resultant bulking system. The second liquid mixture is blended until all components are mixed and the color is dispersed. When the second liquid mixture is added to the mixture existing in the mixing kettle or tank, the heating temperature is preferably maintained within a predetermined temperature range of approximately 200-220 degrees Fahrenheit. It should be appreciated that the mixture may undergo thinning while heat is applied, but blending and heating should occur until the temperature may be maintained in the 200-220 degree Fahrenheit range.

Different acids may be utilized depending on the type of finished product desired. Acids employed may include, but are not necessarily limited to, ascorbic acid, fumaric acid, malic acid, and sodium acid sulfate (also known as pHase). Malic acid is preferably used when a fruit-flavored product is formulated. Malic acid has characteristics that allow for setting the bulking system at low temperature ranges. Ascorbic acid and sodium acid sulfate (also known as pHase) also are preferably used along with fumaric acid to set the gel formed as well as to retard or reduce flatulence. It should be appreciated that the amount of acid used in the second liquid mixture may comprise anywhere from 0 to 5% of the resultant bulking system. Preferably, the acids comprise 1 to 2% of the bulking system and are utilized, in part, to activate the gels in the bulking system to set the formation into a soft candy product. Although only at least one acid is required to form the second liquid mixture, it should be appreciated that at this step, color, flavors, fruit concentrate, and sucralose sweetener or some other high intensity sweetener may preferably be blended with the at least one acid to form the second liquid mixture.

Preferred flavors may be fruit flavors, although other flavors may be added and/or substituted without departing from the present disclosure, such as a chocolate flavor as will later be described. Regardless what flavors are utilized in forming the second liquid mixture, they are preferably concentrated and most often are in liquid form. Preferably the flavor level is at 2% or below. It should be appreciated that when concentrations of the flavor fall below this percentage, off-flavors begin to show up in the finished bulking system due to the carriers in the flavors and the reduction of the other ingredients to make a place for the carriers for flavors.

For added flavor in fruit-flavored bulking systems, a fruit concentrate with essence returned is preferably utilized. Fruit concentrate has the functional attributes of adding particle fibrous pieces and pectin to the bulking system and also is desirable because of its high refractive index. For example, strawberry fruit puree concentrate with essence returned is a preferable fruit concentrate as it is low in calories and is 28-degree brix. It also has the essence returned allowing more flavor for a smaller amount of usage. This fruit concentrate typically comprises less than 1% of the resultant bulking system although it can range from 0 to 5% of the composition. In a preferred embodiment, a pear puree concentrate with essence returned is utilized to allow other flavor profiles to be incorporated into the resultant bulking system.

Dried sucralose sweetener is preferably used for additional flavoring and comprises 0 to 5% of the bulking system, although preferably sucralose comprises less than 1% of the bulking system. A dried form of sucralose is preferred in that the liquid form has polyesters/polysorbates that may adversely affect the resulting bulking system. Various colors can be used depending on the color desired for the bulking system, and the color typically comprises less than 0.01% of the bulking system. When at least one acid, color, flavors, sucralose, water and fruit concentrate are combined to preferably form the second liquid mixture, the components are mixed until the color is well dispersed. The second liquid mixture is then set aside.

Activators may preferably be used in embodiments of the present disclosure. Activators may include potassium or calcium sources, including but not necessarily limited to, calcium malate, tri-magnesium citrate, calcium citrate, calcium lactate, calcium potassium phosphate citrate, and potassium citrate. Preferably activators are employed such that they form 0 to 6% of the resultant bulking system. If such activators are used, activators should be held for addition to the mixture until after the second liquid mixture of at least one acid is incorporated into the mixture as previously described. If a potassium or calcium source is utilized as an activator, this activator should preferably be added to the mixture under high agitation after the second liquid mixture is added and the predetermined temperature range of approximately 200-220 degrees Fahrenheit has been reached.

If an active ingredient is to be incorporated into the bulking system, it should be weighed and held in a separate container until time for blending with the components of the bulking system. An active ingredient should preferably be blended into the mix prior to addition of the second liquid mixture, as the mixture will not have been subjected to a large amount heat at this stage in the blending process. The active ingredient(s) should preferably be added under high agitation, and upon addition, the mixture should be stirred constantly during the blending process in order to ensure even dispersement of the mixture or at least to ensure that the solid portions of the mixture are dispersed. An active ingredient preferably should be added while no heat is being applied to the mixing kettle or tank.

Active ingredients include, but are not limited to: vitamins; minerals; mineral salts; caffeine; pheobromine; central nervous system stimulants; amino acids; appetite suppressants; SSRis; MAOI's; electrolytes; hydroxy citric acid; 5-hydroxy tryptophan (5-HTP); NSAids including acetaminophen, ibuprophen, aspirin or salicylic acid; glycerol; weight loss ingredients; and over-the-counter (OTC) medicines including, but not limited to, allergy/sinus medicines (such as diphenhydramine HCl), cough suppressants (such as dextromephorphan HBr), antihistamines, and nasal decongestants (such as pseudoephedrine HCl) may be added following addition of HSH, if desirable. These active ingredients, if incorporated into the bulking system, typically comprise approximately 3-4% of the resultant bulking system but may range from 0 to 7%. This system for delivery of active ingredients is useful for children as well as adults who would express a preference for ingesting these active ingredients in a soft candy form that may have a more pleasant taste and may be more enjoyable to consume than an active ingredient in pill form, for example.

In some embodiments of the present disclosure, hydrogenated starch hydrolysate (HSH) may be employed as a component of the bulking system. A hydrogenated starch hydrolysate, such as HSH Stabilite SD30, may preferably be used as a bulking agent. SD30 is a hydrogenated starch hydrolysate in spray-dried form that is a low-sweetness powder and can be dissolved in water to produce clear, noncrystallizing syrups.

If HSH is desirable to be used, it may be incorporated into the dry-blended mixture. When it is initially combined with water, the water must be maintained at room temperature in order to ensure adequate mixing and dispersement of HSH in solution. HSH should be weighed and held in a separate container and then mixed into the dry-blended mixture. Should HSH be included as part of the bulking system, it preferably comprises 0 to 4% of the resultant bulking system.

Dimethicone is also known as polydimethylsiloxane (PDMS) and is recognized for its unusual rheological properties. Dimethicone, an ingredient having anti-gas properties, is preferably blended in after addition of the dry-blended mixture. Similar to the weighing of active ingredients, dimethicone or other ingredients having anti-gas properties should be weighed and held in a separate container for later use in the manufacturing process. Dimethicone should be added to the mixing tank under continuous agitation and stirred at a slow to moderate speed to disperse the solid portions of the mixture without thickening the mixture. It is preferable that it be added prior to applying heat to the mixture.

A food-grade plasticizing agent may preferably be incorporated into the bulking system. Several types of food-grade plasticizing agents may be used. In one embodiment of the present disclosure, in an intermediate step following addition of the dry-blended mixture to water, a plasticizing agent, such as paraffin wax, carnauba wax or beeswax, may be weighed and melted in a separate container. Preferably, the wax will melt at approximately 200-212 degrees Fahrenheit. Paraffin wax, if used, preferably comprises approximately 0 to 20% of the resultant bulking system. If carnauba wax is used, it preferably comprises 0 to 60% of the resultant bulking system. This melted wax should be held for later addition in the bulking manufacturing process. In another embodiment of the present disclosure, a food-grade resin such as, but not limited to, shellac resin, may be added in a separate step prior to addition of the second liquid mixture as has been described, and this food-grade resin preferably comprises 0 to 20% of the resultant bulking system. In a further embodiment of the present disclosure, a food-grade gum, such as, but not limited to, mastic gum and pullulan gum, may be incorporated into the dry-blended mixture, and this food-grade gum preferably comprises 0 to 20% of the resultant bulking system.

A plasticizing agent, such as melted paraffin wax or carnauba wax, may preferably be added when the first temperature has been reached. Such an addition should be made under constant slow to medium agitation. However, if other food-grade plasticizing agents, such as food-grade resins or food-grade gums, are to be utilized, these plasticizing agents are preferably added separately prior to addition of the second liquid mixture. After maintaining the first temperature for a period of time and, if a wax plasticizing agent is used, once the combination of ingredients including the melted wax has fully blended, addition of other components of the bulking system, including addition of the second liquid mixture, preferably occurs.

When the predetermined temperature range is reached following addition of the second liquid mixture, the bulking system is ready to be panned, plated or molded. The bulking system is held in kettle/tank 108 at a stable temperature (preferably in the range of 175-185 degrees Fahrenheit) agitated at slow/medium speed until time for depositing. It should be appreciated that the bulking system should be panned, plated or molded as quickly as possible once the predetermined temperature range is reached as it will typically begin to gel upon cooling. Further, once the composition has been plated or molded, it should be allowed to cool before the depanning process is initiated. Alternatively, the resultant composition may be extruded and allowed to cool.

When the bulking system is ready to be deposited, the bulking system is preferably deposited using depositer 109 into specially formed aluminum molded pans that may be fitted in trays 110 normally used in confectionary facilities (FIG. 2, step 205). It should be appreciated that the bulking system should not be deposited in a starch mold given the water content of the bulking system has a tendency to make the starch mold too wet and further, the moisture content of the bulking system may be too high to reuse the starch in the molding process. The bulking system should be spread out around the wall of the aluminum molded pans in order to ensure even distribution of the bulking system. It also should be appreciated that the thickness of the panned layer can vary depending on the texture and thickness desired for the finished product. As an example, if the bulking system is panned in a thicker manner, less steam time may be required, resulting in a finished product that is thicker with less of a crusty outside layer. Aluminum pans that have been super-cooled are preferably used. While aluminum pans are preferably used, it should be appreciated that pans constructed from other materials, including but not limited to, Teflon, plastic and rubber, may be used without departing from the objects of the present disclosure.

The aluminum pans are preferably lightly sprayed with a nozzle applying atomized starch to the top of the tray prior to depositing of the bulking system. While starch is preferably used as it aids in retention of water in the bulking system, other release agents such as silicon oils may be used in conjunction with or in place of starch. Application of starch in this manner allows for easier depanning of the bulking system as the bulking system is less likely to stick to the aluminum pan. Further, use of aluminum pans typically allows for faster cooling of the bulking system.

After depositing the bulking system into aluminum pans, the aluminum pans are introduced into trays 110 that may be rolled into cooling room 111 (FIG. 2, step 206). Pans containing the bulking system preferably remain in cooling room 111 for approximately 0-3 hours prior to depanning (FIG. 2, step 207). It should be appreciated that the pans may be flash frozen to further reduce the cooling time. When the pans are ready for depanning, an air knife preferably sweeps across the pans to sweep excess starch or release agent out of the mold. When the trays have been emptied, the empty trays are re-starched and super- cooled for reuse.

The process described above used to make the novel bulking system is devised so as to produce a product that will plate, mold and/or set faster than prior soft or hard candy products. Temperatures used when the product is at the stage for heating and molding should be kept to a maximum of 195-200 degrees Fahrenheit. Preferably, the bulking system should not remain in the mixing container for more than two hours prior to heating or molding. Once the heating steps are complete, the product should preferably be molded immediately and not left to stand in the mixing container or in packaging equipment.

When the bulking system has been panned for a predetermined range of time, the bulking system is then preferably de-panned. It should be appreciated that the bulking system will likely absorb some of the starch on its outer coating during the panning process, and thus, to the extent starch remains on the bulking system after de-panning, the starch should preferably be removed from the bulking system.

Upon completion of a de-panning process, the bulking system then proceeds into a sanding process. The bulking system is removed from the pan, and any remaining starch is removed from the bulking system. The bulking system is then preferably sent through a steam tunnel where the bulking system is exposed to steam for a brief period of time as is known in the art. It should be appreciated that the bulking system may remain in the steam tunnel for varied amounts of time depending on the texture desired for the bulking system (i.e., more or less crust). The bulking system then is preferably deposited into a container/tumbler that preferably contains a blend of granulated erithritol and calcium silicate and it is tumbled. The erithritol-calcium silicate blend is preferably comprised of 0.5%-2% calcium silicate with the rest comprised of erithritol. Use of calcium silicate is preferable in that it aids the drying process and allows for extended use of erithritol in the sanding process. It also is believed to interact with activators, such as tri magnesium citrate, if present in the bulking system, such that the tri magnesium citrate precipitates out during the sanding process to form a crust-like texture on the bulking system. The bulking system is then sifted out of the erithritol/calcium silicate mixture and packaged for distribution as described below.

Upon depanning or extruding and sanding, the bulking system is preferably packaged in a container, such as a sealable bag, and a nitrogen drop or flush is preferably introduced into the container. This nitrogen introduction is beneficial to maintaining the form and quality of the resultant product in that the nitrogen preferably stops an oxidation process from taking place, allowing the resultant bulking system to retain the flavors and colors in the form that they were introduced into the bulking system. Further, as erithritol comprises a relatively large percentage of the resultant product, introduction of nitrogen preferably retards its crystallization as embodiments of the bulking system which are devoid of nitrogen may only be comprised of as little as one-fourth the percentage of erithritol found in the preferred embodiment of the present disclosure. In addition, nitrogen preferably acts as a thermal insulator to slow down any melting that the resultant product may undergo. This is important because typically sugar-free bulking systems have had a tendency to melt at lower temperatures than are desirable. Introduction of nitrogen into the sealable container holding the bulking system preferably counteracts such tendency.

Finished products can include weight loss snacks and bars that can be either extruded or molded. When a reference is made to extrusion, this is usually when the product is squirted out and then cut, such as when licorice rope or bars are made. When molded, such as molding that takes place with gummy bears, the molds are pressed into cornstarch, the melted ingredients are poured in, and then are finished with a carnauba wax in a panning process. Weight loss/energy/meal replacement bars are extruded. In order to make a bulking system extrudable, one adds flour or a flour analog. Preferably, the flour or flour analog comprises 0 to 15% of the resultant bulking system. A type of flour that may be used is Konjac flour that has high fiber content (such as 95%). Rice flour or starch also may be used. The preference is to use flour that has no glutens. A soy milk powder also may be preferably included with the flour or flour analog to form an extrudable finished product, and if soy milk powder is used, it also preferably comprises 0 to 15% of the resultant bulking system.

Different types of finished product applications formed by the method described in the present disclosure include low-calorie gummy-like products, non-rolled fruit snacks, gummy-like products loaded with vitamins, energy-producing gummy-like products, gummy-like products for weight loss, chocolate chews, fruit extruded bar or rope/twist, as well as hard candies, bars, licorice ropes or analogs, fruit snacks, and rolled fruit snacks. A hard candy coating also may be applied to the bulking system. To form a hard candy coating, the centers of the candy would be deposited into starch molds, and the sanding process described with respect to the soft candy would be replaced with a panning process so as to shellac the candy with a hard coating which is preferably a mixture of sugar alcohols, colors, along with a wax or resin base. Rolled fruit snacks are made by spraying a thin layer of mixed, molten liquid onto wax paper or some other paperlike substrate, and one side of the rolled fruit snack may preferably undergo sanding. Rolled fruit snacks or other fruit snack products, in the context of the described bulking system, contain additionally a low dextrose equivalent (low DE) fruit concentrate with returned fruit essence. While these types of bulking systems are specifically identified, it should be appreciated that other bulking systems may be produced by the process discussed in the context of this disclosure.

In one embodiment of the present disclosure, a soft candy product having a fruit flavor is formed. Erithritol, pectin (such as LM-101 AS/Kelco), gellan gum LT100, gellan gum F/Kelco gel, carageenan iota, and gum Arabic/colony are combined to form a hydrocolloid dry-blend mixture. Erithritol granules preferably comprise approximately 20-30% of the resultant composition, pectin preferably comprises approximately 0.5-2% of the resultant composition, and gums preferably comprise approximately 1 to 5% of the resultant composition. A first liquid mixture is preferably comprised of Litesse ultra liquid. Litesse ultra liquid comprises approximately 0-5% of the resultant bulking system. A second liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry/Bell and Blue Raspberry/Bell) and sucralose. Acids comprise approximately 1-3% of the resultant bulking system, and the remaining components of the second liquid mixture comprise approximately 1-2% of the resultant composition.

Preservatives (such as Glass H and potassium sorbate) are added to water and then dissolved under low agitation without heat. These preservatives preferably form approximately 0.1% of the resulting composition. The hydrocolloid dry-blend mixture is preferably added to the preservative/water mixture in the homogenizer under high shear/agitation and blended until no lumps are visible. This blending process preferably continues for approximately 10-15 minutes depending on the volume of the mixture. Heat may then be applied once the hydrocolloid dry-blend mixture is added and the resultant mixture is transferred to the kettle/tank, and the blend may preferably be heated to a first temperature of at least 190 degrees Fahrenheit.

When this first temperature is reached and even dispersement is achieved, a first liquid mixture of Litesse ultra liquid is then added to the blend under continued agitation. The temperature of the mixture is then preferably increased to a second temperature of approximately 210 degrees Fahrenheit. A second liquid mixture of acids, flavor, sucralose, fruit concentrate and color is then preferably added under medium high agitation. It should be appreciated that the mixture will undergo thinning in texture. Agitation of the mixture should preferably continue until the temperature of the mixture reaches a predetermined temperature range of approximately 200-220 degrees Fahrenheit. When this predetermined temperature range has been reached, the composition that forms is held for later panning or molding.

In this embodiment of the present disclosure, calcium lactate is preferably utilized as an activator. The activators preferably form less than 0.6% of the resultant combination. The activator(s) may be added under high agitation after the predetermined temperature range has been reached and after the second liquid mixture has been added. However, the activator(s) need to be added before the composition is panned.

Variations of the above-described embodiment may be formed wherein, for example, by addition of gelatin, plasticizing agents, dimethicone, active ingredients or HSH as previously described. The hydrocolloid dry-blend mixture as well as the first and second liquid mixtures remain at similar percentages of the resultant soft candy composition even with addition of any or all of the above-described additional ingredients.

In a second embodiment of the present disclosure, a soft candy product is formed without the inclusion of gelatin or pectin in the dry-blended mixture. Erithritol, gellan gum LT 100, gellan gum F/Kelco gel and gum arabic spray dried/colony are combined to form a hydrocolloid dry-blend mixture. Dimethicone is preferably added to a mixture of water, preservatives and the dry-blended mixture following addition of the dry-blended mixture. Similar to the first embodiment described, erithritol granules preferably comprise 15-30% of the resultant composition and gums preferably comprise approximately 0 to 5% of the resultant composition. A first liquid mixture is preferably comprised of Litesse ultra liquid which comprises approximately 0 to 5% of the resultant composition and clarified rice syrup which comprises approximately 0-3% of the resultant composition. Clarified rice syrup may preferably be incorporated into the bulking system as an additional binding agent when gelatin and/or pectin are absent from the bulking system. A second liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry/Bell and Blue Raspberry/Bell) and sucralose. Acids comprise approximately 1-3% of the resultant bulking system, and the remaining components of the second liquid mixture comprise approximately 1-2% of the resultant composition. Beta cyclodextrin then may preferably be added to the mixture following addition of the second liquid mixture. Other than alterations to the composition and process as described above, the process of forming the bulking system with respect to this embodiment of the present disclosure proceeds in the manner described above with respect to the first embodiment. In the present embodiment, calcium lactate is not used as an activator; however, it should be appreciated that an activator could preferably be incorporated into the formulation without departing from the present disclosure. Again, variations of the above-described embodiment may be formed by adding other active ingredients, plasticizing agents or HSH. The hydrocolloid dry-blend mixture as well as the first and second liquid mixtures remain at the same percentages of the resultant soft candy composition even with addition of any or all of the above-described additional ingredients.

In a third embodiment of the present disclosure, a soft candy product is formed wherein gelatin is incorporated into the hydrocolloid dry-blend mixture while pectin is excluded. Specifically, erithritol, gellan gum LT 100, gellan gum F/Kelco gel and gelatin type A 250 bloom are combined to form a hydrocolloid dry-blend mixture. Similar to the above described embodiments, erithritol granules preferably comprise 15-30% of the resultant composition and gums preferably comprise approximately 0 to 5% of the resultant composition. Gelatin preferably comprises 0 to 10% of the resultant composition. Dimethicone is preferably added to a mixture of water, preservatives and the dry-blend mixture following addition of the dry-blend mixture. If desired, ultracel fiber powder may be incorporated into the bulking system after preservatives are added to water but before the dry-blend mixture is added. A first liquid mixture is preferably comprised of Litesse ultra liquid which comprises approximately 0 to 5% of the resultant composition and clarified rice syrup which comprises approximately 0-3% of the resultant composition. Clarified rice syrup may preferably be incorporated into the bulking system as a binding agent when gelatin and/or pectin are absent from the bulking system. A second liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry/Bell and Blue Raspberry/Bell) and sucralose. Acids comprise approximately 1-3% of the resultant bulking system, and the remaining components of the second liquid mixture comprise approximately 1-2% of the resultant composition. Again, other than alterations to the composition of the dry-blend and liquid mixtures as described, the process of forming the bulking system with respect to this embodiment of the present disclosure proceeds in the manner described above with respect to the first embodiment. In the present embodiment, calcium lactate is not used as an activator; however, it should be appreciated that an activator could preferably be incorporated into the formulation without departing from the present disclosure. Again, variations of the above-described embodiment may be formed by adding other active ingredients, plasticizing agents or HSH. The dry-blend mixture as well as the first and second liquid mixtures remain at the same percentages of the resultant soft candy composition even with addition of any or all of the above-described additional ingredients.

In a fourth embodiment of the present disclosure, a soft candy product is formed containing no Litesse in the formulation. Erithritol, gellan gum LT100, gellan gum F/Kelco gel, carageenan iota, and gum Arabic/colony are combined to form a hydrocolloid dry-blend mixture. Erithritol granules preferably comprise approximately 9-30% of the resultant composition and gums preferably comprise approximately 0 to 5% of the resultant composition. A first liquid mixture is prepared comprising ascorbic acid, malic acid, fumaric acid, sodium acid sulfate (pHase), fruit concentrate (such as fruit concentrate Pear/essence returned), colors (such as blue #1 lake), flavors (such as Strawberry/Bell and Blue Raspberry/Bell) and sucralose. Acids comprise approximately 2-3% of the resultant bulking system, and the remaining components of the second liquid mixture comprise approximately 1-2% of the resultant composition.

Preservatives (such as Glass H and potassium sorbate) are added to water and then dissolved under low agitation without heat. These preservatives preferably form approximately 0.1% of the resulting composition. The dry-blend mixture is preferably combined with the preservative/water mixture in the homogenizer under high shear/agitation and blended until no lumps are visible. This blending process preferably continues for approximately 10-15 minutes depending on the volume of the mixture. Heat may then be applied once the dry-blend mixture is added and the resultant blend is transferred to the kettle/mixing tank, and the mixture may preferably be heated to a first temperature of at least 190 degrees Fahrenheit.

A first liquid mixture of acids, flavor, sucralose, fruit concentrate and color is then preferably added under medium high agitation. It should be appreciated that the mixture will undergo some thinning in texture. Agitation of the mixture should preferably continue until the temperature of the mixture reaches a predetermined temperature range of approximately 200-220 degrees Fahrenheit. When this predetermined temperature range has been reached, the composition that forms is held for later panning or molding. It should be appreciated that the resultant composition may have a less smooth texture than other embodiments, and thus, it may be desirable to run the resultant composition through a hydrocolloid mill or an extruder in order to smooth out the texture, particularly if it is desirable to have a finished product such as licorice or an extruded snack bar.

In a fifth embodiment of the present disclosure, a soft candy product is formed. In this formulation, several modifications are made in comparison to the previously described embodiments. For example, a combination of gums, including gellan gum LT100 and gellan gum F/Kelco gel as well as xanthan gum/ISP, is used. An ultracel coarse fiber powder also is incorporated into the bulking system. Further, beeswax forms a part of the bulking system. Erithritol, gelatin type A 250 bloom, gellan gum LT100, gellan gum F/Kelco gel, and xanthan gum/ISP are combined to form a hydrocolloid dry-blend mixture. Erithritol granules preferably comprise approximately 9-30% of the resultant composition, pectin preferably comprises approximately 1-2% of the resultant composition, and gums preferably comprise approximately 0 to 5% of the resultant composition. Dimethicone is preferably added to a mixture of water, preservatives and the dry-blend mixture. If desired, ultracel fiber powder may be incorporated into the bulking system after preservatives are added to water but before the dry-blend mixture is added. A first liquid mixture is preferably comprised of Litesse ultra liquid which comprises approximately 8-10% of the resultant composition and clarified rice syrup which comprises approximately 0-3% of the resultant composition. Clarified rice syrup may preferably be incorporated into the bulking system as a binding agent when gelatin and/or pectin are absent from the bulking system. In an intermediate step, a wax, such as beeswax, may be added separately to the mixture following addition of the first liquid mixture. A second liquid mixture is prepared comprising ascorbic acid, malic acid, fumaric acid, sodium acid sulfate (pHase), fruit concentrate (such as fruit concentrate Pear/essence returned), colors (such as blue lake), flavors (such as Strawberry/Bell and Blue Raspberry/Bell) and sucralose. Acids comprise approximately 2-3% of the resultant bulking system, and the remaining components of the second liquid mixture comprise approximately 1-2% of the resultant composition.

While several embodiments have been described above, it should be appreciated that these embodiments are merely representative of the different formulations contemplated as part of the present disclosure. Other formulations can be made using different combinations and percentages of the components described without departing from the present disclosure. It should be appreciated however that textural differences might occur depending on the composition of the bulking system.

While many of the embodiments described include malic acid as part of the second liquid mixture, it should be appreciated that lactic acid may be substituted for malic acid without appreciably changing the percent composition of the resultant bulking system. Lactic acid is preferably used when the bulking system is to have a brown flavor, meaning that the flavor has been typically derived from two basic thermal processes: caramelization and Maillard reactions. Brown flavors include, but are not limited to, chocolate, vanilla, toffee, mocha, cream/milk, cinnamon and caramel. If lactic acid is preferably used as part of the formulation of the bulking system, it should be appreciated that the colors and flavors incorporated into the second liquid mixture will be altered, as fruit concentrate typically would not be utilized when a brown flavor is desired. In an embodiment of the present disclosure, a chocolate candy may preferably be formed using the bulking system through addition of a form of cocoa (cocoa butter, cocoa solid, cocoa liquor or combinations thereof) along with nonfat milk or cream and optionally additional emulsifiers such as lecithin and/or proteins including, but not limited to, whey protein, soy protein and/or milk protein concentrate, in order to keep the oils together. Other acids including but not limited to glucona delta lactone (GDL), adiptic acid and phosphoric acid may be used in combination with lactic acid without departing from the present disclosure. While more calories may be added to the bulking system to form a chocolate-flavored version, there is still no sugar added and accordingly no laxative effect is felt from ingestion.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for manufacturing a low-calorie, no laxation bulking system, said method comprising:
blending a hydrocolloid dry-blend mixture including at least one gum and erithritol granules with water in a homogenizer to form a first mix;
transferring said first mix to a mixing tank;
adding a first liquid mixture comprising modified polydextrose to said first mix to form a second mix and heating to a first predetermined temperature range of approximately 210 degrees Fahrenheit;
upon reaching the first predetermined temperature range, adding a second liquid mixture comprising at least one acid and flavor to said second mix and cooling to a second predetermined temperature range of approximately 175-185 degrees Fahrenheit to form said low-calorie, no laxation bulking system;
transferring said bulking system to at least one aluminum pan; and
cooling said at least one aluminum pan containing said bulking system in a cooling room for a predetermined range of time.

2. The method of claim 1, said method comprising:
spraying said at least one aluminum pan with an atomized release agent prior to cooling said at least one aluminum pan.

3. The method of claim 1, said method further comprising:
depanning said bulking system into a sealable container; and
introducing nitrogen into said sealable container.

4. The method of claim 1 wherein said homogenizer comprises:
an inlet for receiving said water; and
a hopper for receiving and dispensing said hydrocolloid dry-blend mixture into said homogenizer.

5. The method of claim 4 wherein preservatives are dissolved in the water before the water is received through the inlet.

6. The method of claim 1, said method further comprising:
exposing said bulking system to steam in a steam tunnel upon exiting said cooling room.

7. The method of claim 6, said method further comprising:
sanding said bulking system with a blend of granulated erithritol and calcium silicate upon exiting said steam tunnel.

8. A system for manufacturing a low-calorie, no laxation bulking system, said system comprising:
a homogenizer that meshes a hydrocolloid dry-blend mixture including at least one gum and erithritol with water to form a first mix;
a mixing tank that blends said first mix with a first liquid mixture of modified polydextrose and a second liquid mixture comprising at least one acid and flavor to form a moldable mix;
at least one aluminum pan that receives said moldable mix; and
a cooling room that cools said at least one aluminum pan for a predetermined range of time.

9. The system of claim 8, said system further comprising:
at least one discharge pump attached to said homogenizer for pumping said first mix exiting said homogenizer.

10. The system of claim 9, said system further comprising:
a flow meter attached to said at least one discharge pump to determine the speed of said first mix as it exits said at least one discharge pump.

11. The system of claim 10, said system further comprising:
a heat exchanger attached to said flow meter for heating said first mix before said first mix enters said mixing tank.

12. The system of claim 11 wherein said homogenizer, said at least one discharge pump, said flow meter and said heat exchanger are housed in a single structure.

13. The system of claim 8, said homogenizer further comprising:
at least one adjunct high shear mixer.

14. The system of claim 8, said system further comprising:
a depositer for depositing said moldable mix into said at least one aluminum pan.

15. The system of claim 8, said system further comprising:
a nozzle for spraying said at least one aluminum pan receiving said moldable mix with an atomized release agent.

16. The system of claim 8, said system further comprising:
a steam tunnel wherein when said moldable mix exits said cooling room, said moldable mix is exposed to steam for a period of time.

17. The system of claim 16, said system further comprising:
a tumbler for receiving said moldable mix upon exiting said steam tunnel, said tumbler containing a blend of granulated erithritol and calcium silicate.

18. A method for manufacturing a quick setting, drying and cooling low-calorie, no laxation bulking system, said method comprising:
blending a dry-blended mixture of erithritol granules and at least one gum with water to form a first mix;
mixing modified polydextrose and at least one acid with said first mix to form said bulking system wherein said modified polydextrose is first added to the first mix and heated to a first predetermined temperature of approximately 210 degrees Fahrenheit to form a second mix and then said at least one acid is added to the second mix and cooled to a second predetermined temperature range of approximately 175-185 degrees Fahrenheit;
transferring said bulking system to at least one aluminum pan;
and cooling said at least one aluminum pan containing said bulking system in a cooling room for a predetermined range of time.

19. The method of claim 18, said method further comprising:
spraying an atomized release agent over said at least one aluminum pan containing said bulking system.

20. The method of claim 18, said method further comprising:
exposing said at least one aluminum pan containing said bulking system to steam in a steam tunnel upon exiting said cooling room; and
sanding said at least one aluminum pan containing said bulking system with a blend of granulated erithritol and calcium silicate upon exiting said steam tunnel.
